(19) United States
(12) Patent Application Publication
(10) Pub. No.: US 2015/0330350 A1
(43) Pub. Date: Nov. 19, 2015

(54) STARTER FOR PISTON ENGINE ALLOWING A MITIGATION OF THE RESISTIVE TORQUE

(71) Applicant: SOCIETE DE MOTORISATIONS AERONAUTIQUES, Bourges (FR)

(72) Inventor: Guillaume LABEDAN, Paris (FR)

(73) Assignee: SOCIETE DE MOTORISATIONS AERONAUTIQUES, Bourges (FR)

(21) Appl. No.: 14/651,458

(22) PCT Filed: Dec. 11, 2013
(86) PCT No.: PCT/FR13/53031

§ 371 Date: Jun. 11, 2015

(30) Foreign Application Priority Data
Dec. 11, 2012 (FR) 1261899

(51) Int. Cl. F02N 15/00; F02N 11/00

(52) U.S. Cl. CPC F02N 15/00; F02N 11/00

(57) ABSTRACT

A system for starting a piston engine, including a crankshaft configured to rotate a shaft of the piston engine, a starter, and a sequence of gimbals including at least one universal joint, the series of gimbals including an input shaft configured to be selectively rotatably connected to the starter, and an output shaft rotatably connected to the crankshaft, the sequence of gimbals carry out a transformation of instantaneous rotational velocity of the output shaft relative to the intake shaft that makes it possible to smooth out resistive torque resulting from the compressions.

### GENERAL TECHNICAL FIELD

The present invention relates to the field of piston engines, and more precisely piston engine starters.

### PRIOR ART

In the field of aviation, starters used for starting piston engines are often substantially stressed, due to the substantial cylinder capacities of piston engines relative to automobile applications for which starters are initially designed.

For compression ignition engines, diesel engines for example, this difficulty is even greater due to the high volumetric ratio.

To absorb these high stresses, the starting relay and the battery are dimensioned to absorb the very high intensities in the starter. These intensities are directly caused by the high resistive torque during passage of the compressions of the engine.

Also, for bulk reasons, it can prove advantageous to position the starter in a configuration perpendicular to the crankshaft of the piston engine. Solutions currently used to create a bevel gear to produce this configuration comprise for example an endless screw system with a spring-loaded clutch which manages the coupling of the starter.

But these solutions are not satisfactory in that they lead to oversizing of the different components due to high resistive torque during starting, and insufficient reliability of bevel gear solutions.

### PRESENTATION OF THE INVENTION

The aim of the present invention is to propose a system having none of these drawbacks.

For this purpose, the present invention proposes a system for starting a piston engine, comprising a crankshaft and a starter, said system being characterized in that it further comprises a series of gimbals comprising at least one universal joint, said series of gimbals comprising an input shaft adapted to be selectively linked in rotation to the starter, and an output shaft linked in rotation to the crankshaft, said series of gimbals being configured such that its input shaft and its output shaft are not parallel, and carrying out transformation of the instantaneous speed of rotation of the output shaft relative to the input shaft smoothing the resistive torque due to compressions.

The input shaft and the output shaft of the series of gimbals are typically substantially perpendicular.

According to a particular embodiment, said series of gimbals comprises two universal joints mounted in series and in phase, each of said universal joints performing transformation of the instantaneous speed of rotation of its output shaft relative to its input shaft to reduce the speed of its output shaft relative to its input shaft when the resistive torque is maximum.

Each of said universal joints typically has a breaking angle equal to 45°.

Said reduction in speed of the output shaft relative to the input shaft of the series of gimbals typically reaches substantially 30% when resistive torque is maximal.

According to a particular embodiment, said system further comprises a reducer arranged to connect the starter with the input shaft of the series of gimbals.

According to a particular embodiment, said system comprises an output reducer arranged so as to connect the crankshaft with the output shaft of the series of gimbals, said reducer coinciding the frequency of the law of transformation of speed with the frequency of compressions.

The invention also relates to a piston engine comprising a system such as defined previously.

Said piston engine comprises for example four cylinders in which pistons are moved by the crankshaft.

### PRESENTATION OF FIGURES

Other characteristics, aims and advantages of the invention will emerge from the following description which is purely illustrative and non-limiting and which must be viewed in conjunction with the appended drawings, in which:

FIG. 1 is a schematic illustration of a system according to an aspect of the invention;

FIG. 2 illustrates an example of the evolution of the instantaneous torque caused by compressions and inertia of a piston engine in the absence of combustion.

### DETAILED DESCRIPTION

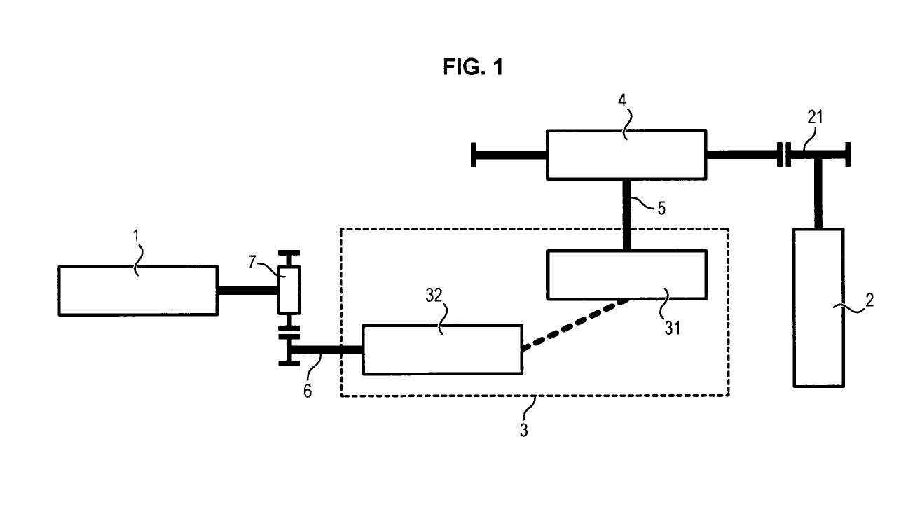

FIG. 1 is a schematic illustration of a system according to an aspect of the invention.

This figure shows a system for starting a piston engine comprising a crankshaft 1 and a starter 2 adapted to be selectively linked to the crankshaft 1 and drive it in rotation.

The starter 2 typically comprises an electric engine attached to a battery, and an output shaft 21.

The system as presented further comprises a series of gimbals 3 comprising one or more universal joints mounted in series, and ensuring a link between the starter 2 and the crankshaft 1. The series of gimbals comprises an input shaft 5 to which torque is applied by the starter 2, and an output shaft 6 driving the crankshaft 1 in rotation. In the embodiment shown, the series of gimbals 3 comprises two universal joints, respectively 31 and 32, mounted in series.

Also, in the embodiment shown, a reducer 4 is arranged between the starter 2 and the series of gimbals 3 to apply a reduction ratio between the output shaft 21 of the starter 2 and the input shaft 5 of the series of gimbals 3. An output reducer 7 is arranged between the crankshaft 1 and the output shaft 6 to conserve the same frequency between the universal joints of the series of gimbals 3 and the compressions of the engine associated with the crankshaft 1.

In fact, one of the characteristics of linking via a universal joint is that the law of transformation of speed is double in frequency relative to the frequency of rotation.

A system comprising such a universal joint can therefore filter only those compressions occurring every multiple of 180°, which corresponds to the periodicity of compressions for a four-cylinder engine and is therefore adapted to such an engine.

For an engine with a different number of cylinders, it is necessary to pass by transmission ensuring an adequate speed ratio so as to have the frequency of the law of transformation of speed coincide with the frequency of compressions, which produces the different reducers.

To produce substantial reduction ratios while preserving the gain in bulk, it is possible to use several gears in series or an epicycloidal train, to the detriment of the total mass of the system.

The series of gimbals advantageously exploits the non-homokinetic character of the link created by a universal joint to attenuate and smooth the resistive torque to which the starter 2 is subjected, as will be detailed hereinbelow.

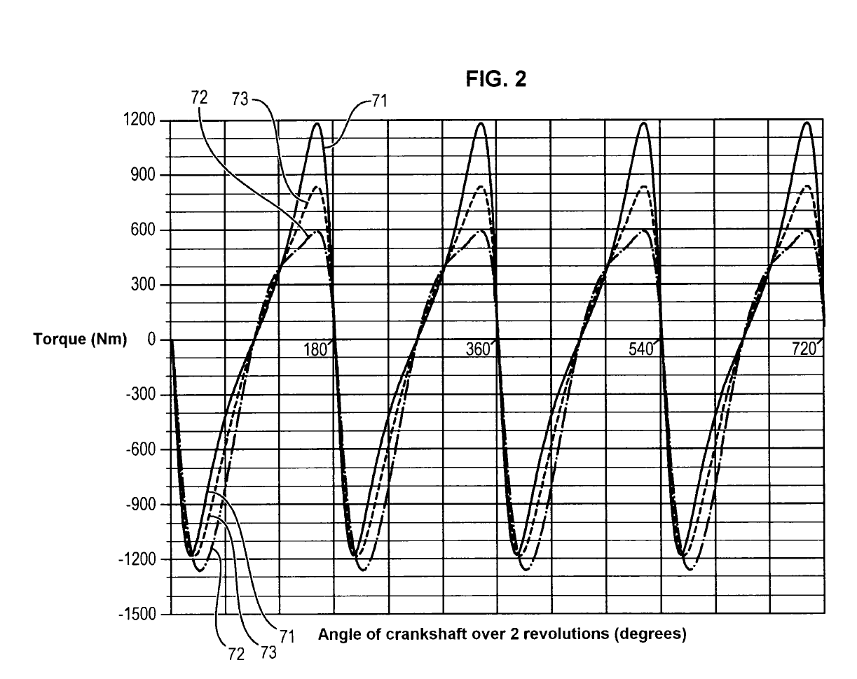

FIG. 2 shows an example of the evolution of instantaneous torque (in Nm) caused by compressions and inertia of a piston engine in the absence of combustion as a function of the rotation of the crankshaft, expressed in degrees.

Three distinct curves are marked on this graph, respectively showing
Curve 71: instantaneous torque at the level of the crankshaft 1.
Curve 72: instantaneous torque at the level of the starter 2.
Curve 73: instantaneous torque on the shaft between the two universal joints 31 and 32 shown in FIG. 1.

These different curves illustrate a succession of compressions, defining a high dead point every 180° (or semi-evolution) of the crankshaft 1, just before which resistive torque is maximum. FIG. 2 shows in fact that resistive torque reaches its maximal value just before 180°, then changes direction by shifting from zero to 180°. The operation is periodic every 180°.

In fact, rotation of the crankshaft 1 causes displacement of pistons and consequently of successive cycles of compression and relaxing, and consequently variable resistive torque, which increases during compression to reach its maximal value just before the high dead point, then becomes an engine during relaxing.

FIG. 2 shows the effect of the series of gimbals 3 on instantaneous resistive torque, in particular just before the high dead point, while resistive torque reaches its maximal value; resistive instantaneous torque is sharply reduced at the level of the starter 2 relative to the resistive instantaneous torque at the level of the crankshaft 1.

In fact, a universal joint does not transmit the speed of rotation constantly during rotation when the two axes of the universal joint are not aligned.

Considering a universal joint comprising an input shaft and an output shaft gives the relation Cin×Win=Cout×Wout, or Cin=Win/Wout×Cout, where
Cin is the torque applied to the input shaft,
Cout is the torque applied to the output shaft,
Win is the speed of rotation of the input shaft, and
Wout is the speed of rotation of the output shaft.

As a consequence, due to variation in the Win/Wout ratio, the ratio between the input torque and the output torque can also be varied, and resistive torque applying to the starter 2 can be attenuated.

For a given universal joint, the Win/Wout ratio depends especially on the breaking angle between the input shaft and the output shaft of the universal joint.

The different universal joints are configured to obtain the preferred ratio.

The breaking angle of each of the universal joints is typically between 30° and 60°, for example equal to 45°.

According to a particular embodiment, the series of gimbals 3 comprises two universal joints each exhibiting a breaking angle of 45°, the total breaking angle of the series of gimbals 3 being equal to 90°. Such a configuration creates a good compromise between the forces being exerted on the universal joints and the instantaneous transformation in speed to reduce the maximum resistive torque.

The increase in the breaking angle improves the effect on the reduction in resistive torque, but causes an increase in stresses being exerted on the universal joint. Inversely, a reduction in the breaking angle reduces stresses being exerted on the universal joint, but reduces its impact on the reduction in maximum resistive torque.

Also, a series of gimbals 3 comprising two universal joints each having a breaking angle of 45°, and therefore having a total breaking angle equal to 90° improves the compactness of the engine.

Given the system presented in FIG. 1, the universal joint 32 is configured advantageously such that the instantaneous speed of rotation of the output shaft of this universal joint 32, in this case the output shaft 6 of the series of gimbals 3, is greater than the instantaneous speed of rotation of the output shaft of this universal joint 32, in this case the intermediate shaft between the two universal joints 31 and 32 shown in FIG. 1, at the instant when resistive torque is maximum. The average speed between the input and output shafts is identical between the input shaft 5 and the output shaft 6 of the series of gimbals 3; the series of gimbals 3 causing transformation of the law of speed so as to modify the instantaneous speed just before the high dead point, to reduce the maximum resistive torque.

Given the example of the curves shown in FIG. 2 corresponding to two consecutive universal joints having each a breaking angle of 45°, the ratio between input torque and output torque at the instant when the resistive torque is maximum just before the high dead point is substantially equal to 850/1200=70%; the ratio between output speed and input speed is therefore also of the order of 70% at this instant.

Similarly, the ratio between input torque and output torque at the instant when the resistive torque is maximum just before the high dead point of the universal joint 31 is substantially equal to 600/850=70%; the ratio between output speed and input speed is therefore also of the order of 70% at this instant.

So, mounting two universal joints in series, each performing transformation of instantaneous speed and mounted in phase such that their properties of non-homokinetics are added, advantageously and substantially reduces by half the maximum resistive torque being exerted on the starter.

In addition, assembly is advantageously carried out so as to attenuate resistive torque before the high dead point without affecting engine torque after the high dead point.

In addition, use of a series of gimbals 3 comprising at least one universal joint to create the link between the starter 2 and the crankshaft 1 positions the starter 2 on an axis non-parallel to the axis of the crankshaft 1, which is advantageous in terms of bulk.

The proposed system has several advantages relative to a conventional starter.

In the first place, the proposed system attenuates the instantaneous torque at each compression. For the same starter, this therefore allows starting which is more fluid with less risk of stopping on compression.

Also, smoothing of the torque to which the starter 2 is subjected during the high dead point reduces irregularities in torque between the starter 2 and the reducer 4, improving the longevity of the system.

Also, due to this smoothing of torque, the intensity peaks passing through the starter 2 and the commonly associated electrical components such as a battery and an electrical relay are diminished during starting, with the exception of a starting phase during which the speed is substantially zero and when friction is predominant, reducing the risk of damage to the system by heating the components.

Another result of this is a decrease in the need for current, which allows use of a more compact electrical starting system, or increase the number of possible starting events between two battery recharges of such an electrical starting system.

1-9. (canceled)

10. A system for starting a piston engine, comprising:
a crankshaft;
a starter;
a series of gimbals comprising at least one universal joint, the series of gimbals comprising an input shaft configured to be selectively linked in rotation to the starter, and an output shaft linked in rotation to the crankshaft, the series of gimbals being configured such that its input shaft and its output shaft are not parallel, and carrying out transformation of instantaneous speed of rotation of the output shaft relative to the input shaft to reduce maximum resistive torque due to compressions.

11. The system according to claim 10, wherein the input shaft and the output shaft of the series of gimbals are substantially perpendicular.

12. The system according to claim 10, wherein the series of gimbals comprises two universal joints mounted in series and in phase, each of the universal joints carrying out transformation of the instantaneous speed of rotation of its output shaft relative to its input shaft to reduce a speed of its output shaft relative to its input shaft when the resistive torque is maximum.

13. The system according to claim 12, wherein each of the universal joints has a breaking angle equal to 45°.

14. The system according to claim 12, wherein the reduction of the speed of the output shaft relative to the input shaft of the series of gimbals goes as far as substantially 30% when the resistive torque is maximum.

15. The system according to claim 10, further comprising a reducer configured to connect the starter with the input shaft of the series of gimbals.

16. The system according to claim 10, further comprising an output reducer configured to connect the crankshaft with the output shaft of the series of gimbals.

17. A piston engine comprising a system according to claim 10.

18. The piston engine according to claim 17, comprising four cylinders wherein pistons are shifted by the crankshaft.
